(19) United States
(12) Patent Application Publication
(10) Pub. No.: US 2005/0071808 A1
(43) Pub. Date: Mar. 31, 2005

(54) Generic development tools for embedded software design

(75) Inventor: Gabriele Luculli, Montbonnot (FR)

Correspondence Address: SEED INTELLECTUAL PROPERTY LAW GROUP PLLC, 701 FIFTH AVENUE, SUITE 6300, SEATTLE, WA, 98104-7092, US

(73) Assignee: STMicroelectronics, S.A., Montrouge (FR)

(21) Appl. No.: 10/666,725

(22) Filed: Sep. 19, 2003

(51) Int. Cl. G06F 9/44

(52) U.S. Cl. 717/106; 717/100

(57) ABSTRACT

Process for processing an executable embedded software code, said process comprising: reading an executable embedded code for one predetermined processor; extracting code sections from said executable embedded code; reading a file containing a description of a set of instructions for said predetermined processor, based on the concepts of TOKEN, FIELDS, ATTRIBUTES and CONSTRUCTORS of the SLED language, enriched with an additional CLASS definition grouping different instruction under a same label; and using said description in order to derive from said TOKEN, FIELDS, ATTRIBUTES, CONSTRUCTORS and CLASS an internal representation taking the form of a decision tree.

### BACKGROUND OF THE INVENTION

1. Field of the Invention

The present disclosure relates generally to software design, and more particularly but not exclusively to a process and tools for generic software development.

2. Description of the Related Art

Computing engineering has known a substantial increase in the productivity of software design for many years, thanks to the development of effective design tools for the analysis and the optimization of software, such as assemblers, instructions set simulators (ISS) and static code analyzers.

A disassembler—also known under the expression “decompiler” in the case of high level languages such as the C, PASCAL etc.—is known in the art as allowing the generation of an assembler source code from a binary executable code.

An instruction set simulator (ISS) is a second development tool which is used for providing a virtual simulation of the hardware machine (i.e., core processor with bus and memory subsystems) wherein an executable code is being loaded. With such a helpful tool, software designers can simulate the internal behavior of one particular machine where an executable code would be loaded. With this tool, one can optimize the code and ascertain that the technical choices made in the design of the architecture are fully appropriate and compatible.

A third tool is the static code analyzer. Such a tool—also particularly helpful for design software program—provides an automatic analysis of one particular executable code and outputs useful information regarding the structure of the executable code such as the basic blocks boundaries, the different procedure therein included etc.

Such design tools are very useful when a new machine based on a microprocessor has to be developed. However, those tools need to be designed themselves and such additional time might be a tricky problem for the short time to market required for some widely marketed products. In addition, those widely marketed products, such as mobile telephone, camcorders etc. are frequently highly specialized materials, based on microprocessors using embedded software which may know substantial changes in their architecture between two consecutive generations of machines. While in “general-purpose” computer, the architecture generally remains relatively unchanged; this is no longer true for specialized products such as those mentioned above. Indeed, for the purpose of incorporating new functions, the high technology products see their architecture substantially modified in order to increase the performances. Changes may be brought to the processor, to the bus, to the organization of the memory and even new instructions can be added in order to add new powerful functions. All those changes clearly result in the need to re-design, at each time, the set of software tools required for analyzing and simulating the embedded software.

Generally speaking, in order to improve the productivity of the design process and reduce the time to market, several efforts have been done for automating the development of design software tools such as disassemblers, Instructions Set Simulators (ISS) and Static Code Analyzers for a new, or even partially new, microprocessor. This concept is generally referred to as “automatic retargetability.”

Known techniques of automatic retargetability are usually based on many different specifications of the given instruction set in order to separately produce, in an automated forms, the three different design tools.

The following references are prior art references:
1. “Generation of software tools from processors descriptions for hw/sw co-design,” M. R. Haartog et al., IEEE Proc. of 34^{th} DAC, June 1997.
2. “Pragmatic aspects of reusable program generators,” Norman Ramnsey, Journal of Functional Programming 13(3):601-646, May 2003.
3. “Retargetable compiled simulation of embedded processors using a machine description,” S. Pees, A. Hoffmanm H. Meyr, ACM Transaction on Design Automation of Electronics Systems, 5(4):815-834, January 2000.

Obviously, the adoption of different specifications, instead of a single one, increases the time and the work to be done by engineers for specifying a given instruction set. In addition, the prior art technique, which is known under the concept of program generation, is based on the idea of using the machine specification to generate off-line a custom design tool for each given specification. Of course this process is repeated each time that the specification is changed, even in a minor detail. So, even if this is a form of automatic retargetability, the adoption of a off-line paradigm and a particular specification for each specific tool may require a substantial time which clearly reduces the practical benefits of this automatic retargetable approach.

### BRIEF SUMMARY OF THE INVENTION

An aspect of the present invention provides a new process providing a retargetable technique for rapidly redesigning engineering tools for embedded software.

An aspect of the present invention reduces the time to market of embedded software by improving the development of design tool for such embedded software.

A further aspect of the present invention provides a retargetable design tool facilitating the development of a disassembler, a Instructions Set Simulator (ISS) or a Static Code analyzer.

One embodiment of a process for processing an executable embedded software code comprises the following steps:
reading an executable embedded code for one predetermined processor;
extracting the code sections from said executable embedded code;
reading a file containing a description of a instruction set for said predetermined processor, based on the concepts of TOKEN, FIELDS, ATTRIBUTES and CONSTRUCTORS of the SLED language, enriched with an additional CLASS concept which is used to group different instruction classes under a same label; and
using said description in order to derive in an automatic on-line fashion from said TOKEN, FIELDS, ATTRIBUTES, CONSTRUCTORS and CLASS an internal representation which takes the form of a decision tree.

In one particular embodiment, the internal representation is used for deriving the disassembled code corresponding to said executable embedded software code.

More particularly, every piece of embedded software code is processed as follows:
starting from the first root node and ending with a leaf node of said decision tree and
determining one unique path comprising the true branches—having values corresponding with the contents of said code sections—ending with a leaf node and executing all tests within said path in order to identify the instruction corresponding to said piece of embedded software code; and
repeating the preceding step until all the software embedded code is processed.

The internal representation can also be used for automatic retargeting other design tools such as a Static code analyzer and even a Instruction Set Simulators (ISS).

### BRIEF DESCRIPTION OF THE DRAWINGS

A non-limiting embodiment of the invention will now be described, by way of example only, with reference to the accompanying drawings, wherein:

FIG. 1 illustrates the general process of the embodiment of the invention providing a common internal representation.

FIG. 2 shows an example of a decision tree used for the internal representation.

FIG. 3 illustrates an embodiment of the process for generating a Static Code Analyzer.

### DETAILED DESCRIPTION OF THE INVENTION

Embodiments of generic development tools for embedded software design are described herein. In the following description, numerous specific details are given to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

It should be desirable to improve the retargetability by providing a sort of generic software design tool with the great capability of automatic on-line adapting to each given specification. That is, to adopt an automatic on-line retargetable approach. This method could be much more effective even when the architecture is subject to some minor change.

The article “An ISA-Retargetable Framework for embedded Software analysis,” published by the inventor of the present application on Apr. 2, 2003 on the 10^{th} IEEE International Conference and Workshop on Engineering of Computer-Based Systems, deals with the general problem of providing an automatic on-line retargetable technique for improving the productivity of the generation of software design tools.

An embodiment of the present invention is based on the use of the Specification Language for Encoding Decoding (SLED) which provides a precise a specific specification of a given set of instructions and its encoding. As known in the prior art, SLED language is used for carrying out, in the known program generation approach, a disassembler or a Instructions Set Simulator (ISS). It should be noted that the SLED allows the specification of the encoding of an instruction set, but not its semantic.

SLED is not part of the present invention and, therefore, will not be further developed. However, full detail regarding the different concepts of SLED can be found in the following technical references:

<<Specifying representations of machines instructions>>, Norman Ramsey and Mary F. Fernandez, ACM Transaction on Programming Languages and Systems, 19(3): 492-524, May 1997.

In accordance with one embodiment of the present invention, the SLED language is now used for the representation of the encoding of a given set of instructions, in one particular architecture. This encoding is read through a specific interface to a development or design tool which therefore becomes generic and can be used in a wide variety of architectures.

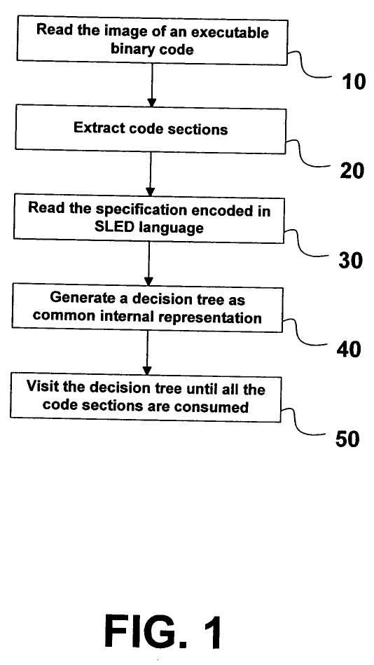

With respect to FIG. 1, there will now be described the process executed in accordance with an embodiment of the present invention.

The process comprises a first step 10 where a file containing the image of an executable binary code is read and loaded within the memory. Numerous formats can be used for this file, such as the known Executable and Linkable Format (ELF), Common Object File Format (COFF), Intel Hex Format for others.

Clearly, the skilled man will apply the teaching of the present invention to the use of any equivalent format. It should be observed that the executable code is the code for a specific processor—known as “embedded”—which is generally not the same processor (laptop or Personal Computer) where the design tool is being executed and, more particularly, on which the process of an embodiment of the invention is executed.

In a step 20, the process extracts from the image loaded in step 10 the different code sections forming part of that code. Such operation is well known to the skilled man and, therefore, will not be elaborated further on.

In a step 30, the process reads a description of a set of instructions of said embedded processor, written in the SLED language. For the sake of illustration, one finds below an example of such a description for a typical processor comprising a unique format as follows:

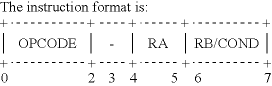

The OPCODE indicates a numerical code which is representative of the particular instruction to execute. The second field—carrying the symbol “-”—contains one unique bit that may have any value, 0 or 1, and which is not important in this specific case for the instructions encodings; so we indicated it with the dash symbol to mean “don't care value.” RA defines the first operator of the instruction which is considered and the next field RB/COND corresponds to a second operator, with a double function, which is useful when two different operators are involved in the considered instruction. In some cases, the second field corresponds to the second register which is used by the instruction. In the case of a conditional jump (JMPC) instead, this second field encodes the condition to be evaluated true in order to take the jump.

For instance, a possible condition to execute a conditional jump is that his first operand is positive (other possible conditions are that it is negative or equal to zero); such conditions are encoded by the RB/COND field.

In the example which is considered, the following instructions are given:

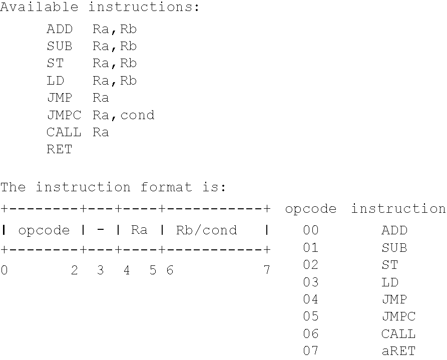

The set of instructions which is given above with their encoding, corresponds to the following SLED description:

| | |
|---|---|
| 1. | token ITOKEN (8), |

| | |
|---|---|
| 2. | fields |

| | |
|---|---|
| 3. | opc 0:2 ra 4:5 rb 6:7 |

| | |
|---|---|
| 4. | cc 6:7 |
| 5. | |

| | |
|---|---|
| 6. | patterns |

| | |
|---|---|
| 7. | [ADD SUB ST LD JMP JMPC CALL RET] is opc={0 to 7} |
| 8. | |
| 9. | arith is ADD \| SUB |
| 10. | ldst is LD \| ST |
| 11. | |

| | |
|---|---|
| 12. | constructors |

| | |
|---|---|
| 13. | arith Ra, Rb is arith & Ra=ra & Rb=rb |
| 14. | ldst Ra, [Rb] is ldst & Ra=ra & Rb=rb |
| 15. | |
| 16. | JMP [Ra] is JMP & Ra=ra |
| 17. | |
| 18. | JMP\hat{ }COND [Ra] is JMPC & Ra=ra & COND=cc |
| 19. | |
| 20. | CALL Ra is CALL & Ra=ra |
| 21. | RET is RET |
| 22. | |

| | |
|---|---|
| 23. | classes for CFG |

| | |
|---|---|
| 24. | jmp is JMP |
| 25. | jmpc is JMP\hat{ }COND |
| 26. | call is CALL |
| 27. | ret is RET |
| 28. | other is ADD \| SUB \| ST \| LD |

As can be seen above, the description in SLED of the encoding of the set of instructions is based on the concepts of TOKEN, of FIELD (comprising in sub-parts of the said TOKEN), of PATTERN (comprising in one association of FIELD and one value which is used for testing purpose), and CONSTRUCTOR (comprising in an organized set of PATTERN), as defined in the above mentioned article of Ramsey's which is incorporated by simple reference.

The description in SLED of the encoding of the instruction set comprises one definition for each of the above mentioned concept.

Regarding the concept of TOKEN, it can be seen that one unique 8-bit TOKEN is considered (line 1), which is partitioned in the four following FIELDs (lines 2-4):
opc ;ra ;rb ;cc

Regarding the concept of PATTERN, one observes that the specification in SLED of the encoding comprises one multiple definition (line 7), defining a set of eight PATTERNs: ADD, SUB etc. Then two additional definitions (lines 9-10) are used to declare two additional patterns as composition of the previously defined ones. Clearly, this is only given by way of example and the skilled man will adapt the teachings to any kind of processor.

Referring to concept of CONSTRUCTORS, it can be seen that the specification in SLED comprises a set of six elementary definitions, that is to say the specification of lines 13-21, with the two former comprising in multiple definitions and the four latter being simple definitions.

In addition to the above mentioned concepts, known from the Ramsey's et al article, an embodiment of the invention uses an additional concept of CLASS which is used to partition the set of recognized instructions into independent sets. This is done practically by affixing a label, among the available one (i.e., jmp, jmpc, call, ret, other), to each class of recognized instruction. This new one enriches the description of the set of instructions which is provided by the known SLED definition and will allow to derive, as will be shown in step 40 of the FIG. 1, a common internal representation of the set of instructions, useful for the automatic retargeting of different software design tools.

Considering again the example shown above, it can be seen that one class jmp comprises the unique instruction JMP and that a so-called class other comprises the instructions ADD, SUB, ST (Store) and LD (Load).

It can be seen, on that example shown for the sake of clarity, that it becomes possible to encode, thanks to the SLED language enriched with the CLASS definition, the instruction set of any kind of processor. This description is provided to the process in accordance with one embodiment of the present invention and is read by said process in a step 30.

In a step 40, the process elaborates the description read in step 30 and it builds an internal representation, which will serve as a common representation for the automatic on-line retargeting of all design tools, and in particular the disassembler, the Instructions Set Simulator (ISS) and the Static Code Analyzer.

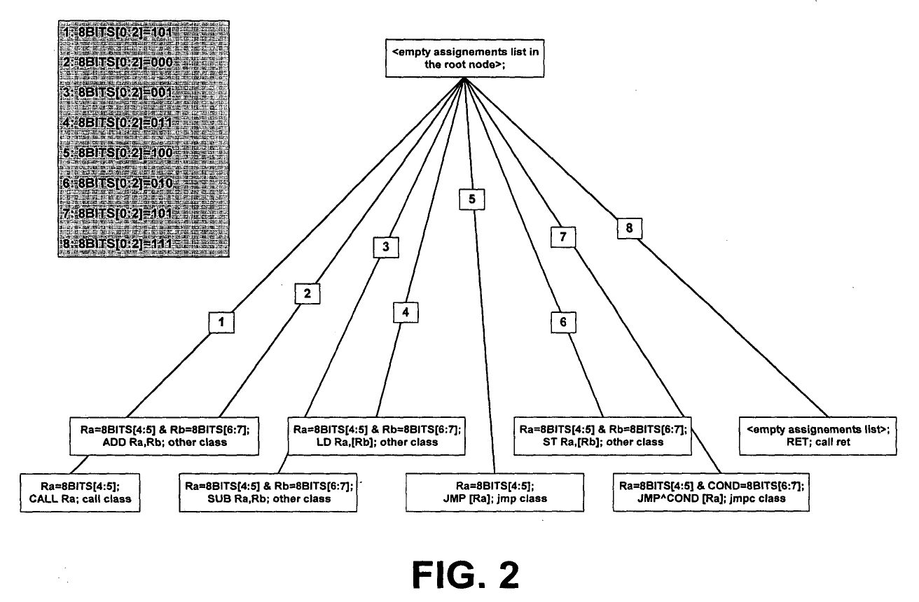

FIG. 2 illustrates the common representation applicable to the example which was discussed above.

Decision tree:

| | |
|---|---|
| [ROOT] | +−(8BITS[0:2]=000)→ [Ra=8BITS[4:5] & Rb=8BITS[6:7]; ADD Ra, Rb; other] |
| | \| |
| | +−(8BITS[0:2]=001)→ [Ra=8BITS[4:5] & Rb=8BITS[6:7]; SUB Ra, Rb; other] |
| | \| |
| | +−(8BITS[0:2]=011)→ [Ra=8BITS[4:5] & Rb=8BITS[6:7]; LD Ra, Rb; other] |
| | \| |
| | +−(8BITS[0:2]=010)→ [Ra=8BITS[4:5] & Rb=8BITS[6:7]; ST Ra, Rb; other] |
| | \| |
| | +−(8BITS[0:2]=101)→ [Ra=8BITS[4:5] & COND=8BITS[6:7]; JMP\hat{ }COND [Ra]; jmpc] |
| | \| |
| | +−(8BITS[0:2]=101)→ [Ra=8BITS[4:5]; CALL Ra; call] |
| | \| |
| | −(8BITS[0:2]=111)→ [; RET; ret] |

As it can be see, this internal representation takes the form of a decision tree which is elaborated from the concepts of CONSTRUCTOR, TOKEN, FIELD, PATTERN, and CLASS defined above.

Every node of the decision tree is associated to a list of FIELD assignments and each branch corresponds to a list of tests carried out between the actual contents of the FIELD and one particular value being considered in the branch. It should be noted that the leaf node of the decision tree, comprise, in addition to the list of field assignment mentioned above, two additional elements of information. A first element of information defines the string of characters which is representative of the assembler syntax of the recognized instruction. A second element of information is the CLASS which is associated to the instruction which is considered.

On the whole, the set of branches of the decision tree of FIG. 2 defines all the possible values for the different FIELDs, those FIELDs being necessary for recognizing each particular instruction in an executable code. The current values which will be used in the next step of the process of the invention—be it for the purpose of generating a disassembler or a Instruction Set Simulator (ISS) or a Static Code Analyzer—are the values which are extracted from the executable code read in step 20.

In the example shown above, it can be seen that the branch number one comprises one unique test on the FIELD designated opc comprising bits 0, 1 and 2 of the 8-bits TOKEN. In this first branch, the process compares the value of opc with the binary string 101 that is the decimal value 5.

In the other branches, we can see the same comparison between the same FIELD opc and the successive values which can receive this field.

Practically, one of the many possible algorithms to generate the decision tree is the following:
1. To identify the available TOKENS with their characteristic length in bits;
2. To identify the available FIELDS, inside each TOKEN, and their characteristics bits range;
3. To identify the available elementary PATTERNS (i.e., a PATTERN is elementary if it is defined only in term of FIELDS and not in term of other PATTERNS) and represent each of them in a disjunctive normal form (as reported in the paper of N. RAMSEY). The adopted normal form has a three level structure. The first level contains disjunctions which are combined among them by the SLED operator “|”. In the second level, each disjunction is decomposed into sequences which are combined by the SLED concatenation operator “;”. In the last level each sequence is decomposed into a list of mathematical constraints between a given FIELD and some of its possible values.
4. To identify the available non-elementary PATTERNS. Since each of this PATTERN is defined in term of some previously defined PATTERNS, use the previous disjunctive normal forms of such PATTERNS to build the new disjunctive normal form of this non-elementary PATTERN. In practice, the composition of several disjunctive normal forms may be done by composing each of the three level as suggested in the paper of N. RAMSEY and always obtaining a final disjunctive normal form.
5. To identify the available CONSTRUCTORS and to decompose each of them in a sequence of PATTERNS and a sequence of value-FIELDS assignments. Each PATTERN is represented in a disjunctive normal form so at the end it is a list of mathematical constraints for some particular FIELDS of each TOKEN. Such constraints are represented in the branches of the decision tree. The sequences of the second level of a PATTERN are represented by a sequence of branches in the decision tree. Finally, different disjunction of the first level of a PATTERN represents different output independent branches of the decision tree. The sequences of value-FIELDS assignments which are specified in the CONSTRUCTORS becomes the content of the nodes of the decision tree.
6. At this point we have a decision tree which is almost complete. We simply have to identify the available CLASSES in the SLED specification and to associate to each leaf node of the decision tree its own CLASS. Such association is done by relating the name of the CONSTRUCTOR of each leaf node to the SLED specification.

Therefore, it can be seen that the process of an embodiment of the invention permits to build an internal representation, taking the form of a decision tree as illustrated in FIG. 2 starting from a SLED specification read in step 30.

Very surprisingly, this internal representation can then be used either for the on-line retargeting of a disassembler, a static code analyzer and even an instruction set simulator (ISS).

I. Realization of an On-Line Retargetable Disassembler

This is illustrated by step 50 of FIG. 1.

The process uses the code sections extracted in step 20 and loaded into the memory and also the decision tree elaborated in step 40. Each of the code section takes the form of a sequence of bits which is compared to the different FIELDS values which are defined in the branches of the decision tree of the internal representation of FIG. 2. To achieve this, the process visits the decision tree, by means of any useful algorithm, starting from the first root node and ending to a leaf node. Each time that a new branch is visited, a string of bits of length equal to the TOKEN of the actual branch is read from the code sections and it is considered as an actual value of the branch TOKEN. If the tests which are present in the actual branch are all true, then the branch is taken and the same TOKEN is used in the following node. Otherwise, if even a single test is false, the branch is not taken; so the string of bits of the actual TOKEN is pushed back in the code section, and the process keep progressing on a brother branch. While doing this, the process determines the unique path comprising the true branches—having values corresponding with the contents of code sections read in step 20—and which ends to a leaf node. All the tests defined in the decision tree are being executed for that purpose for determining the true branches, said true branches defining the unique path which is searched leading to one leaf node corresponding to the recognized instruction. The information which are in the reached leaf node represent the recognized instruction in terms of assembler syntax and class of the instruction. The leaf node which is reached then uniquely identifies the instruction which is actually recognized. So a part of the code sections has been effectively disassembled as we wanted. If not all the code sections have been read then the process is kept progressing by starting from the root node again. The process can then reiterate the precedent step until the whole executable code is disassembled.

II. Realization of an On-Line Retargetable Static Code Analyzer

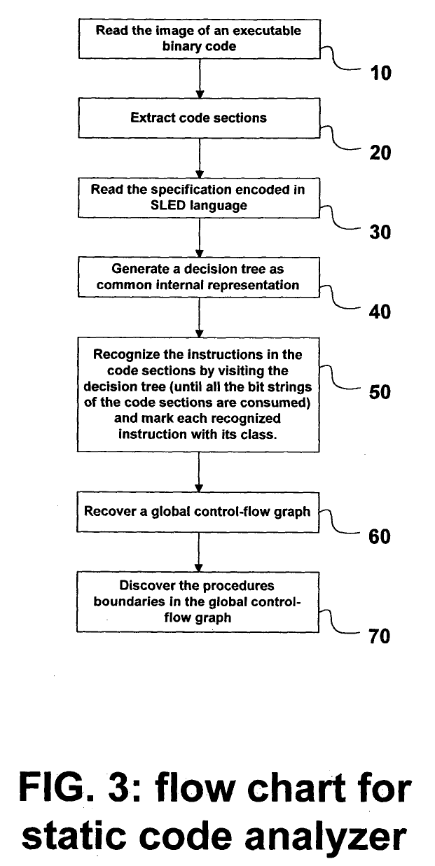

This is illustrated by step 50, 60, 70 of FIG. 3. The steps 10-40 in FIG. 3 are exactly the same steps 10-40 of FIG. 2. This shows that the derived internal representation of step 40 can be effectively shared among several design tools (in our specific case the disassembler and the static code analyzer), so it is a useful common representation as we claims.

The process in step 50 of FIG. 3 is an extension of the process in step 50 of FIG. 2. The extension regards the single fact that following the recognition of an instruction, when a leaf node is reached in the tree visit, such recognized instruction is marked with the class that is found in the leaf node. In this way, each recognized instruction is marked with a label among the pre-defined ones of jmp, jmpc, call, ret, other.

The process in step 60 of FIG. 3 exploits the sequence of recognized instructions with their class label in order to recover a global control-flow graph of the executable code. This process can be done in several ways, as it is widely reported in the research literature in the subject. For the skilled person, it is sufficient to observe that, in any case, the availability of marked instructions, due to internal representation of step 40, is the enabling factor to develop this process.

The process in step 70 of FIG. 3 use the recovered global control-flow graph of step 60, to discover the procedures boundaries of the executable code. Again, this process can be done in several way, as it is widely reported in the research literature in the subject. For the skilled person, it is sufficient to observe that, in any case this process is feasible with the available information derived from the previous steps.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention and can be made without deviating from the spirit and scope of the invention.

These and other modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

1. A process for processing an executable embedded software code, said process comprising the steps of:
reading an executable embedded code for one given processor;
extracting code sections from said executable embedded code;
reading a file containing a description of a set of instructions for said given processor, based on concepts of TOKEN, FIELDS, ATTRIBUTES and CONSTRUCTORS of a SLED language, enriched with an additional CLASS definition grouping different instructions under a common label; and
using said description to derive from said TOKEN, FIELDS, ATTRIBUTES, CONSTRUCTORS and CLASS an internal representation taking a form of a decision tree.

2. The process according to claim 1 wherein said decision tree is followed by an algorithm to derive a disassembled program corresponding to said executable embedded code.

3. The process according to claim 2 wherein each piece of embedded code is processed as follows:
starting from a root node and ending to a leaf node of said decision tree;
determining a unique path comprising true branches, having values corresponding to contents of said code sections, ending to a leaf node and executing all tests within said path to identify an instruction corresponding to said section of embedded software code; and
repeating the preceding step until all the embedded code is processed.

4. The process according to claim 1 wherein said internal representation is used for automatically retargeting a Static Code Analyzer which comprises the following steps:
following recognition of an instruction, when a leaf node is reached in a tree visit, such recognized instruction is marked with a class that is found in the leaf node;
exploiting a sequence of recognized instructions with their class label in order to recover a global control-flow graph of the executable embedded code; and
discovering procedures boundaries of the executable embedded code by using the recovered global control flow graph.

5. A method, comprising:
reading a first file having an image of executable binary code for a processor;
extracting code sections forming parts of the executable binary code from the image;
reading a second file having a description of a set of instructions for the processor;
using the description to derive a decision tree representation; and
for each code section, progressing through the decision tree representation to derive at least a portion of a disassembled program corresponding to the executable binary code, until substantially all code sections are disassembled.

6. The method of claim 5 wherein the description of the set of instructions for the processor is based on Token, Fields, Attributes, Constructors, and Class concepts from Specification Language for Encoding Decoding (SLED).

7. The method of claim 5 wherein progressing through the decision tree representation for each code section includes:
starting at a root node of the decision tree representation, determining a path including branches having values corresponding to contents of the code section, until ending at a leaf node;
executing tests within the path to identify an instruction, at the leaf node, corresponding to the code section; and
repeating the determining a path in the decision tree and executing tests therein for each of the other code sections.

8. The method of claim 7, further comprising:
selecting a branch if a test in that branch yields a true result, and then progressing to a next node; and
otherwise not selecting a branch if a test in that branch yields a false result, and then progressing to another branch.

9. The method of claim 7, further comprising:
after identifying an instruction when a leaf node is reached, marking that instruction with a class label that is present at that leaf node;
recovering a global control flow graph of the executable binary code by using a sequence of identified instructions with their class labels; and
using the recovered global control flow graph to determine procedures boundaries of the executable binary code.

10. An article of manufacture, comprising:
a machine-readable medium having instructions stored thereon to:
read a first file having an image of executable binary code for a processor;
extract code sections forming parts of the executable binary code from the image;
read a second file having a description of a set of instructions for the processor;
use the description to derive a decision tree representation; and
for each code section, progress through the decision tree representation to derive at least a portion of a disassembled program corresponding to the executable binary code, until substantially all code sections are disassembled.

11. The article of manufacture of claim 10 wherein the description of the set of instructions for the processor is based on Token, Fields, Attributes, Constructors, and Class concepts from Specification Language for Encoding Decoding (SLED).

12. The article of manufacture of claim 10 wherein the instructions to progress through the decision tree representation for each code section includes instructions to:
starting at a root node of the decision tree representation, determine a path including branches having values corresponding to contents of the code section, until ending at a leaf node;
executing tests within the path to identify an instruction, at the leaf node, corresponding to the code section; and
repeat the determining a path in the decision tree and executing tests therein for each of the other code sections.

13. The article of manufacture of claim 12 wherein the machine-readable medium further includes instructions stored thereon to:
select a branch if a test in that branch yields a true result, and then progress to a next node; and
otherwise not select a branch if a test in that branch yields a false result, and then progress to another branch.

14. An article of manufacture, comprising:
a machine-readable medium having instructions stored thereon to:
extract code sections forming parts of an executable code;
load a description of a set of instructions;
use the description to derive a decision tree representation; and
for each code section, progress through the decision tree representation to identify an instruction from the set of instructions that corresponds to the code section, until substantially all code sections have been disassembled via identification of each to an instruction.

15. The article of manufacture of claim 14 wherein the description of the set of instructions is based on Token, Fields, Attributes, Constructors, and Class concepts from Specification Language for Encoding Decoding (SLED).

16. The article of manufacture of claim 14 wherein the instructions to progress through the decision tree representation for each code section includes instructions to:
starting at a root node of the decision tree representation, determine a path including branches having values corresponding to contents of the code section, until ending at a leaf node;
execute tests within the path to identify an instruction, at the leaf node, corresponding to the code section; and
repeat the determining a path in the decision tree and executing tests therein for each of the other code sections.

17. The article of manufacture of claim 16 wherein the machine-readable medium further includes instructions stored thereon to:
select a branch if a test in that branch yields a true result, and then progress to a next node; and
otherwise not select a branch if a test in that branch yields a false result, and then progress to another branch.
